(19) United States
(12) Patent Application Publication
(10) Pub. No.: US 2018/0223756 A1
(43) Pub. Date: Aug. 9, 2018

(54) THERMAL MANAGEMENT OF AFTERTREATMENT SYSTEMS

(71) Applicant: Caterpillar Inc., Peoria, IL (US)

(72) Inventors: Wesley G. Benson, Peoria, IL (US); Colleen J. Anderson, Germantown Hills, IL (US); Joseph K. Getz, Morton, IL (US); Allen R. Bowman, Lafayette, IN (US); William B. Marcum, Lafayette, IN (US); Brandon T. Shull, Lafayette, IN (US)

(73) Assignee: Caterpillar Inc., Peoria, IL (US)

(21) Appl. No.: 15/427,093

(22) Filed: Feb. 8, 2017

(51) Int. Cl. F02D 41/02; F01N 3/08; F01N 11/00; F01N 9/00

(52) U.S. Cl. CPC F02D 41/0235; F01N 3/0835; F01N 11/00; F01N 9/005; F01N 2560/023; F02D 2200/08; F01N 2560/07; F01N 2570/12; F01N 2900/0601; F01N 2900/1404; F01N 2900/1411; F01N 2560/06

(57) ABSTRACT

A method for operating an aftertreatment system of an engine is disclosed. The method includes measuring, using one or more sensors, at least one operating parameter of the engine system; estimating, by a controller, a mass of hydrocarbon retained by an aftertreatment component using the at least one operating parameter; determining, by the controller, a percent load of hydrocarbon using the mass of hydrocarbon; comparing, by the controller, the percent load to a predetermined hydrocarbon load threshold; and providing at least one alert indicating a need to initiate a stepwise increase in an engine power to one or more predetermined engine speeds for one or more predetermined durations, if the percent load exceeds the predetermined hydrocarbon load threshold.

### TECHNICAL FIELD

The present disclosure relates generally to a method of operating an aftertreatment system, and, more particularly, relates to a strategy for thermal management of aftertreatment systems in internal combustion engine systems.

### BACKGROUND

Exhaust aftertreatment systems in fossil fuel powered combustion engines, such as diesel engines, typically include aftertreatment components, such as a selective catalytic reduction (SCR) catalyst, a diesel oxidation catalyst (DOC), and the like. SCR catalysts typically facilitate a reduction and/or a removal of gaseous compounds, such as of nitrogen oxides (NOx) from exhaust gas of such engines, while DOCs generally function to oxidize hydrocarbon emissions of the exhaust gas.

The working of aftertreatment components, such as the SCR catalyst, the DOC, and similar other aftertreatment components, are generally temperature dependent. For example, when it is required for combustion engines to idle for prolonged periods, such as for up to 12 hours, a temperature of the exhaust gas may recede to a relatively low level, at which point aftertreatment components may fail to effectively oxidize hydrocarbons accompanying an exhaust gas release. Low ambient temperatures around the engine may further lower the exhaust temperature and aggravate the situation. Hydrocarbons released by the engine during such conditions may flow into a stream of the exhaust gas and be absorbed into chemically active sites present on the catalysts of the aftertreatment system. A presence of relatively high levels of hydrocarbons on the catalyst may degrade the catalyst's performance and may also lead to increased gaseous emissions and a vulnerability of catalyst damage.

U.S. Pat. No. 8,818,659 ('659 reference) relates to a supervisory thermal management system and method for engine system warm up and regeneration. The thermal management system and a method of the '659 reference discusses recommending an operational behavior to an operator of an engine system so that the operator can optimize fuel economy over a period of time in which components of the engine system is in a warm up and/or regeneration state. More specifically, the '659 reference discusses a recommendation for a shift in a transmission gear in view of expected temperature changes to the engine system.

### SUMMARY OF THE INVENTION

In one aspect, the disclosure is directed towards a method for operating an aftertreatment system of an engine. The method includes measuring, using one or more sensors, at least one operating parameter of the engine system; estimating, by a controller, a mass of hydrocarbon retained by an aftertreatment component using the at least one operating parameter; determining, by the controller, a percent load of hydrocarbon using the mass of hydrocarbon; comparing, by the controller, the percent load to a predetermined hydrocarbon load threshold; and providing at least one alert indicating a need to initiate a stepwise increase in an engine power to one or more predetermined engine speeds for one or more predetermined durations, if the percent load exceeds the predetermined hydrocarbon load threshold.

In another aspect, the disclosure relates to an aftertreatment system. The aftertreatment system includes an aftertreatment component, one or more sensors, and a controller. The aftertreatment component is configured to receive exhaust gas from an engine. The sensors are configured to measure at least one operating parameter of the engine system. The controller is in communication with the sensors and the engine and is configured to estimate a mass of hydrocarbon retained by an aftertreatment component using the at least one operating parameter. Further, the controller is configured to determine a percent load of hydrocarbon using the mass of hydrocarbon and compare the percent load to a predetermined hydrocarbon load threshold. Next, the controller is configured to provide at least one alert indicating a need to initiate a stepwise increase in an engine power to one or more predetermined engine speeds for one or more predetermined durations, if the percent load exceeds the predetermined hydrocarbon load threshold.

In yet another aspect, the disclosure is directed towards an engine system. The engine system includes an aftertreatment system that is adapted to treat exhaust gas of an engine. The aftertreatment system includes an aftertreatment component, one or more sensors, and a controller. The aftertreatment component is configured to receive exhaust gas from an engine. The sensors are configured to measure at least one operating parameter of the engine system, while the controller is in communication with the sensors and the engine and is configured to estimate a mass of hydrocarbon retained by an aftertreatment component using the at least one operating parameter. The controller is configured to determine a percent load of hydrocarbon using the mass of hydrocarbon and compare the percent load to a predetermined hydrocarbon load threshold. Further, if the percent load exceeds the predetermined hydrocarbon load threshold, the controller is configured to provide at least one alert indicating a need to initiate a stepwise increase in an engine power to one or more predetermined engine speeds for one or more predetermined durations.

### BRIEF DESCRIPTION OF THE DRAWINGS

FIG. 1 is a schematic and a diagrammatic illustration of an exemplary engine system having an engine and an aftertreatment system, in accordance with the concepts of the present disclosure;

FIG. 2 is an exemplary flowchart depicting an exemplary method of operation of the aftertreatment system, in accordance with the concepts of the present disclosure; and

FIG. 3 is an exemplary strategy of operating the aftertreatment systems in two different engine hardware sets of the engine system, in accordance with the concepts of the present disclosure.

### DETAILED DESCRIPTION

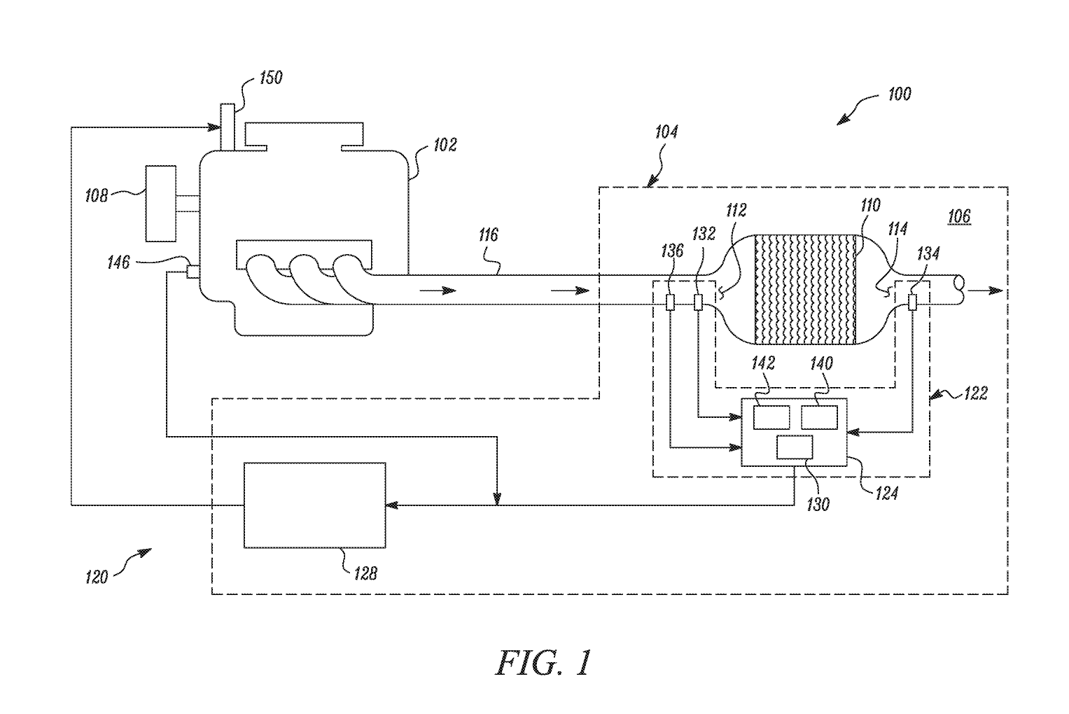

Referring to FIG. 1, there is shown an engine system 100. The engine system 100 may include an internal combustion engine 102 (or simply an engine 102) and an aftertreatment system 104. The aftertreatment system 104 may be configured to treat a quantity of exhaust gas received from the engine 102. Certain exemplary aspects of present disclosure may be discussed envisioning a use of the engine system 100 in a marine vessel (not shown). In this regard, the engine system 100 may include more than a single engine—such as a propulsion engine to propel the marine vessel and an auxiliary engine to power auxiliary requirements of the marine vessel. In some implementations, therefore, the engine 102 may be representative of both such engines, each having separate engine ratings, and a description of the engine 102, may be applied to both such engines. For example, when the engine 102 is applied in a marine vessel as the auxiliary engine, the engine 102 may drive a generator 108 (shown exemplarily in FIG. 1) to produce electrical power. A coupling of such an auxiliary engine to the generator 108 to produce electrical power is well known and will not be discussed.

Nonetheless, aspects of the present disclosure may be applicable in a variety of other environments. For example, the aspects may be applied to engines employed within construction machines, such as off-highway trucks, loaders, tractors, excavators, dozers, loaders, compactors, etc. Further, use of one or more of these aspects may also be extended to stationary machines, such as power generation systems and other electric power generating machines, for example Diesel Electric Propulsion (DEP) units and Land Drilling units. For the purposes of the present disclosure, a power of the engine 102 may be inferred as either of an output of the generator 108, a speed of the engine 102 or a mechanical resistance (or a load) of a propulsion engine. Although the present disclosure contemplates the employment of a multi-cylinder diesel engine, as engine 102, aspects of the present disclosure need not be limited to any engine type.

The aftertreatment system 104 may be applied for treating exhaust gas released from the engine 102. It may be noted that while the term “exhaust gas” may indicate a substance that is primarily gas phase, exhaust gas, as a byproduct of combustion, may also include substances in solid phase or liquid phase. For example, particulate matter within the exhaust gas may be in solid or liquid phase. Therefore, the term “exhaust gas” is intended to refer to all such substances generated as byproducts of combustion within the engine 102. It is thus possible that the exhaust gas released from the engine 102 be laden with a quantity of gaseous forms of hydrocarbons (or simply hydrocarbons, hereinafter). In this regard, the aftertreatment system 104 may receive and process the exhaust gas so as to effectively oxidize the hydrocarbons, before venting out the exhaust gas into an environment 106. The aftertreatment system 104 may include one or more of a Selective Catalytic Reduction Catalyst (referred to as an SCR catalyst), a Diesel Oxidation Catalyst (referred to as a DOC), and/or a Diesel Particulate Filter (referred to as a DPF) to remove undesirable constituents such as hydrocarbons from the exhaust gas. In an embodiment, the SCR catalyst is configured to convert nitrogen oxides in the exhaust gas into diatomic nitrogen and water; the DOC is configured to oxidize the hydrocarbons and carbon monoxide of the exhaust gas into carbon dioxide and water; and the DPF is configured to filter or separate soot or diesel particulate matter from the exhaust gas. For the purposes of the present disclosure, each of the SCR catalyst, the DOC, and the DPF, may be collectively referred to as an aftertreatment component 110, or simply a component 110.

In some implementations, a cleanup catalyst (e.g., an ammonia adsorbing catalyst—AMOx catalyst), which may facilitate a treatment of the exhaust gas prior to an emission of the exhaust gas into the environment 106, may also be applied as the component 110. It is also possible that the component 110 includes and/or represents other similar types of components or catalysts of the art that receive the exhaust gas and are used to convert, reduce, trap, remove, or otherwise condition, constituents of the exhaust gas, produced by engine 102.

It may be noted that the component 110 may be configured to operate optimally when exposed (at least periodically) to the exhaust gas at temperatures that are above a predetermined temperature threshold. For example, a particular catalyst, such as the SCR catalyst, may only convert or reduce constituents of the exhaust gas at a desired rate when the exhaust temperature is sufficiently elevated. For exemplary purposes alone, the predetermined temperature threshold for the component 110 may be 200° C., and below such a predetermined temperature threshold, the component 110 may be unable to function effectively, such as to oxidize the hydrocarbons.

The component 110 may include an inlet 112 to receive the exhaust gas, and an outlet 114 to release a treated quantity of the exhaust gas to the environment 106. In some implementations, the aftertreatment system 104 may include an exhaust conduit 116 fluidly coupled between the inlet 112 and the engine 102, that allows the component 110 to receive the exhaust gas from the engine 102, during operations. Under low load conditions, such as during engine idling, or when a temperature of the environment 106 is under sub-freezing conditions, it is possible that a temperature of the exhaust gas at the inlet 112 may recede below the predetermined temperature threshold. For the purposes of the present disclosure, a dropped temperature or a receded temperature at the inlet 112 of the component 110 below the predetermined temperature threshold may be referred to as ‘low exhaust gas temperature’. To enable an optimum operation of the component 110, the aftertreatment system 104.

Further, the aftertreatment system 104 includes a thermal management system 120 that may include a monitoring arrangement 122 having a controller 124, an interface 128, and a set of sensors, namely a first sensor 132, a second sensor 134, and a third sensor 136.

The monitoring arrangement 122 may be configured to estimate a mass of hydrocarbon (HC), also referred to as HC content, absorbed or retained by the component 110. Such an estimation may be carried out during a low load condition or an idling condition of the engine 102, for example. The set of sensors 132, 134, and 136, may help with the estimation of such an HC content. In this regard, the set of sensors 132, 134, and 136, may help measure at least one operating parameter of the engine system 100 (or the aftertreatment system 104). Further, the controller 124 of the monitoring arrangement 122 may be configured to relay data, pertaining to the HC content, to the interface 128.

The forthcoming description discusses various embodiments of estimating the HC content in the component 110. An estimation of the HC content may be performed by using lesser or all of the sensors 132, 134, and 136. It may be noted that the three sensors 132, 134, and 136, are depicted for explanation purposes alone and does not limit aspects of the present disclosure in any way.

According to a first embodiment of the present disclosure, an estimation of the HC content on the component 110 may be performed by the first sensor 132 and the third sensor 136 alone, and the second sensor 134 may be omitted. In this regard, the first sensor 132 may be a temperature sensor that determines an operating parameter of the engine system 100 (aftertreatment system 104)—that is a temperature of the exhaust gas at the inlet 112 of the component 110. To this end, the first sensor 132 may be positioned at the inlet 112 of the component 110. The third sensor 136 may be an engine sensor that may be located at a suitable position on the exhaust conduit 116, as may be contemplated by someone in the art, to help estimate another operating parameter—a total mass of an exhaust flow (or a mass flow of the exhaust gas), also at the inlet 112. A concentration of HC and flowrate, such as in grams/hour, may be derived from calibrated maps and adjustments due to a temperature of an engine coolant of a coolant circuit (not shown) of the engine 102 and timing adjustments due to a cold engine operation. As a result, a measure of the HC content present on the component 110 may be estimated.

According to a second embodiment, only the first sensor 132 and the second sensor 134 may be used. In such a case, the second sensor 134 may be positioned at the outlet 114 of the component 110, while a position of the first sensor 132 may remain unchanged. Each of the first sensor 132 and the second sensor 134 may be configured to detect a measure of one or more of a property (that is an operating parameter of the aftertreatment system 104), such as pressure, of the exhaust gas passing across the inlet 112 and the outlet 114, respectively, at any given point of time. For example, a pressure differential of the exhaust gas, detected by the sensors 132, 134, across the inlet 112 and the outlet 114, may help deduce an HC content retained by the component 110. In yet another example, larger the pressure differential, higher may be the HC content absorbed or retained by the component 110. In this regard, the first sensor 132 and the second sensor 134 may be one of a pair of pressure sensors that may be together configured to detect the pressure differential. Over a period, every unit change in the pressure differential may be tallied against a pre-stored map data of the HC content on the component 110, and thus with every unit change in the pressure differential, an HC content may be estimated. Such tallying and estimation may be performed by a microprocessor 130 of the controller 124, while the map data may be stored within a memory 140 of the controller 124.

While it is possible for the controller 124 to estimate the HC content based on a pressure differential, the controller 124 may also verify that a temperature of the exhaust gas at the inlet 112 has receded below the predetermined temperature threshold before such an estimation. In this regard, the third sensor 136 may be optionally applied to serve as a temperature sensor. The controller 124 may be coupled to the third sensor 136, so as to seek a measure of temperature of the exhaust gas at the inlet 112 before the estimation.

As with the determination of the pressure differential, in a third embodiment, the sensors 132, 134 may also be a pair of temperature sensors that are configured to determine a temperature differential across the inlet 112 and the outlet 114. Similar to the second embodiment described above, every unit change in the temperature differential, may be tallied against a pre-stored map data of the HC content on the component 110, and with every unit change in the temperature differential, an HC content may be estimated. As with the embodiment of the pressure differential above, the tallying and the subsequent estimation of the HC content may be performed by the microprocessor 130, while the map data may be stored within the memory 140.

It is possible that the first sensor 132 and the second sensor 134 also determine other similar operating parameters, such as a density and a viscosity of the exhaust gas to deduce the HC content retained by the component 110. In this regard, the first sensor 132 and the second sensor 134 may be capacitive sensors suited for detection of multiple parameters, such as each of a density, a viscosity, a temperature, a pressure, a flow rate, etc., of the exhaust gas. In still some implementations, each of the first sensor 132, the second sensor 134, and the third sensor 136 may be a transducer or an analog device that is adapted to convert a detected signal into an electrical (or voltage) signal, and transmit the electrical signal to the controller 124, so that the electrical signal may be processed by the controller 124.

Optionally, it is possible that the monitoring arrangement 122 includes an HC sensor (not shown) such as of a semiconductor HC sensor type having a material that absorbs combustible gases (HC and/or CO). Based on the amount of combustible gases absorbed by such a sensor, a conductivity of the sensor may change, and which may be detected, thereby providing an indication of an HC content in the component 110. While each of these embodiments discussed above provide possible ways to estimate the HC content in the component 110, none of these embodiments need to be seen as being limiting in any way.

In yet other embodiments, one or more engine system parameters can be provided to an engine out HC estimator (not shown) to measure an amount of unburnt HC present in an exhaust stream, to in turn estimate an unutilized HC content, and thus a percent load of the HC content on the component 110. Such parameters may include the fuel being injected into the engine 102, the engine speed, the engine timing, an exhaust flow mass, a coolant temperature, an ambient temperature and pressure, and other parameters that may be stored in the various control modules of the engine 102. Once such parameters are provided to the engine out HC estimator, the engine out HC estimator may use various known maps or look up tables for a particular engine type to provide an estimate of unutilized HC. Such an estimate may be further provided to an HC mass integrator (not shown), which determines the amount of HC added or removed to subsequently calculate an overall HC mass accumulated onto the component 110.

The controller 124 may be configured to receive data pertaining to the estimated HC content on the component 110 from one or more of the sensors 132, 134, and 136, associated with either of the embodiments discussed above. Based on the estimated HC content, the microprocessor 130 may determine a percent load of the HC content on the component 110 using a map data. For example, if a maximum HC load carrying capacity of the component 110 is 100 grams of HC (which may be a predefined quantity), and the estimated HC content is 80 grams of HC, then the percent load may be determined to be 80%. The microprocessor 130 may then be configured to compare such data against a predetermined HC load threshold, such as a percent load threshold. For example, if the percent load threshold was 70% and the estimated HC content has a percent load of 80%, the controller 124 may estimate that the HC content (or the percent load) on the component 110 has exceeded the predetermined HC load threshold. If the controller 124 determines excess HC content, the controller 124 may provide a signal or generate at least one alert indicating the need for an operator of the engine system 100 to initiate the scheme 300 (discussed later). It may be appreciated that the maximum HC load carrying capacity of the component 110 may change based on various factors, such as component aging, etc.

In still some embodiments, the controller 124 may include a timer 142 and may receive input from the timer 142. By being in communication with either of first sensor 132 and/or the third sensor 136, whichever is applied as a temperature sensor, the controller 124 may receive data related to a temperature of the exhaust gas at the inlet 112, and by receiving data from the timer 142, the controller 124 may determine a period for which the temperature at the inlet 112 is maintained at the low exhaust gas temperature′. With every unit passage of time, an increase in the HC content on the component 110 may be estimated. For example, longer a period for which the inlet 112 remains at the low exhaust gas temperature′, larger may be the HC content deposited on the component 110. In this regard, the memory 140 may store a data chart (or a map data) by which the controller 124 may tally every unit passage of time against a pre-specified HC content. Therefore, once a certain time has passed (such as a predetermined period), it may be estimated that a percent load of the HC content has exceeded the predetermined HC load threshold. Therefore, in some implementations, the monitoring arrangement 122 may be defined by the third sensor 136 and the controller 124 alone, while the first sensor 132 and the second sensor 134 may be altogether omitted from the monitoring arrangement 122.

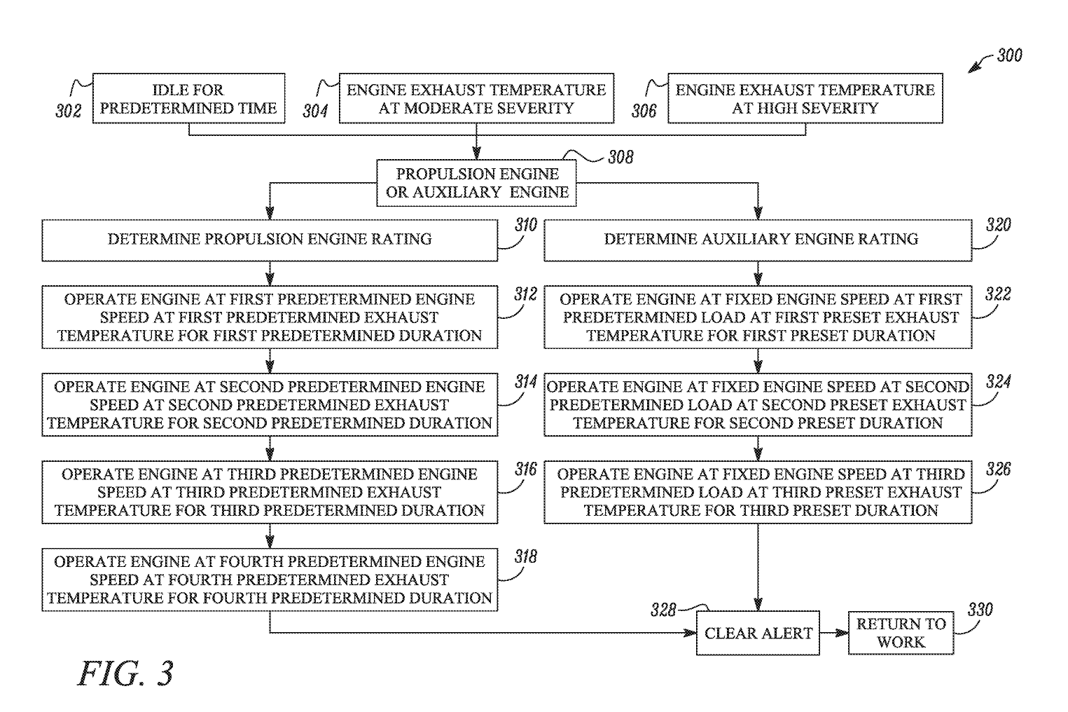

While it is possible to use the third sensor 136 and the controller 124 to determine data pertaining to an HC content, as noted in the above discussion, the controller 124 may still verify such data using either of the aspects described in the first, second, or third embodiment. Such a verification may be useful to save time and effort from unnecessarily executing further stages of an operation of the thermal management system 120. According to an aspect of the present disclosure, further stages of an operation of the thermal management system 120 may refer to a scheme 300 (see FIG. 3) that is applied for lowering the HC content on the component 110. Details of such a scheme 300 is discussed later in the application.

While the controller 124 may be in communication with the sensors 132, 134, and 136, in some implementations, the controller 124 may also be in communication with the engine 102. By being in communication with the sensors 132, 134, and 136, the controller 124 may be configured to receive data indicating HC content on the component 110—as noted above. By being in communication with the engine 102, the controller 124 may be configured to determine one or more working parameters of the engine 102. For example, a working parameter of the engine 102 may include an operational speed (such as rotations per minute (rpm)) of the engine 102. In this regard, the controller 124 may be in communication with a crank sensor 146 of the engine 102 that helps determine an angular velocity of the engine's crankshaft (not shown), and which in turn helps determine the operation speed of the engine 102. In an embodiment, the controller 124 may determine whether the engine 102 has been operating below a predetermined speed (such as a first predetermined engine speed or an idle speed) by receipt of an input from the crank sensor 146. If it is determined that the engine 102 has been operating below the predetermined speed, only then may the controller 124 generate the alert. In one example, the predetermined speed may be a preset idle speed of the engine 102. Such a determination may be needed since typically idling with low or no loads (such as below 20% load) may create a situation for more deposit of HC.

In some further implementations, it is possible that the controller 124 may seek an input pertaining to the HC content from the sensors 132, 134, and 136, for verification alone. In such an instance, the controller 124 may be configured to generate or provide the alert depending solely upon a running period of the engine 102 and an engine speed data received from the crank sensor 146. A running period may be a time for which the engine 102 is operating at a preset idle speed, and may be determined by the timer 142. In an example, if the running period exceeds a predefined idling time, and if it is communicated by the crank sensor 146 that the engine 102 had been operating below the predetermined speed, the controller 124 may be configured to provide the alert. In one example, the running period is 12 hours. However, before providing the alert, a verification from the sensors 132, 134, and 136 may be sought, to determine that the HC content on the component 110 has actually exceeded the predetermined HC load threshold. In such cases, the controller 124 may generate the alert before the running period has elapsed.

In one example, the alert generated by the controller 124 may be served to an operator of the engine system 100 as a first alert that indicates a ‘moderate severity state’ of the component 110. Subsequent to further operation of the engine 102 for another predetermined period, the controller 124 may be configured to serve the operator of the engine 102 with another alert (or a second alert) that indicates a ‘high severity state’ of the component 110. While it may happen that the controller 124 generates two such successive alerts, aspects of the present disclosure are not limited to any number of alerts that the controller 124 may generate. Rather, a lower and/or a higher number of alerts may be contemplated to be generated by the controller 124. In one embodiment, each successive alert may indicate a successively higher level of severity of the component 110. In an embodiment, each alert generated by the controller 124 may be delivered to the interface 128, and the interface 128 may be in turn configured to output or indicate the alert, or alerts, as and when they are generated by the controller 124.

In an embodiment, a rate of HC deposit on the component 110 may trigger the alert, or alerts. For example, data from the sensors 132, 134, and 136, indicating a presence of the HC content may change faster than expected. In such a case, the controller 124 may be configured to generate the alert well before the HC content on the component 110 exceeds the predetermined HC load threshold.

The controller 124 may include power electronics, preprogrammed logic circuits, data processing circuits, associated input/output buses, volatile memory units, such as random access memory (RAM) to help process signals received from the sensors 132, 134, and 136, and the engine 102. To this end, the controller 124 may be a microprocessor based device, or may be implemented as an application-specific integrated circuit, or other logic device, which provide controller functionality, and such devices being known to those with ordinary skill in the art. In some implementations, the controller 124 may form a portion of one of the engine's electronic control unit (ECU), such as a safety module or a dynamics module, or may be configured as a stand-alone entity. Further, the controller 124 may include an analog to digital converter (not shown) that may be configured to receive electrical signals from each of the sensors 132, 134, 136, and 146, to convert the electrical signals into feedback-specific format. The controller 124 may condition these signals for processing by the built-in microprocessor 130.

The memory 140 may be configured to store a set of instructions and values that pertain to the predetermined speed, the predetermined temperature threshold and the predetermined HC load threshold, and/or certain instructions relating to the performance of the scheme 300 (discussed later). The memory 140 may be built-in memory units of the controller 124. However, the memory 140 may also be an entity independent of the controller 124. For example, the memory 140 may be a portable memory device, and therefore, may be an external storage device such as including hard drives, pen drives, flash drives, etc. Further, the memory 140 may include volatile and non-volatile memory units, such as dynamic random access memory (DRAM), static random access memory (SRAM), read only memory (ROM), programmable read only memory (PROM), erasable programmable read only memory (EPROM), electric erasable programmable read only memory (EEPROM), etc. Further, the controller 124 may include power electronics, preprogrammed logic circuits, data processing circuits, volatile memory, non-volatile memory, software, firmware, combinations thereof, or any other controller structures known in the art. In general, links between the controller 124, the sensors 132, 134, and 136, the interface 128 (described below), and the engine 102, may include wired and/or wireless connections.

The interface 128 may be a display with ready access to an operator of the engine system 100, and through which various activities related to an engine operation may be performed. To this end, the interface 128 may be coupled to the controller 124 and to one or more of an input device 150 associated with engine operation. In one example, the input device 150 may include an engine throttle that is adapted to regulate an engine operation, such as a fueling of the engine 102. As an example, the interface 128 may be a touch screen that may receive one or more instructions from the controller 124, and by being coupled to the engine throttle, such a touch screen interface may also facilitate a variation of the engine throttle (input device 150) to regulate engine fueling (and thus engine power). Optionally, the interface 128 may work in conjunction with several control input devices associated with other known operations of the engine system 100, such as those that facilitate connection/disconnection of a load to the engine 102. In this regard, the engine 102 may be connected to a mechanical load (not shown) that is configured to convert a rotational output from engine 102 to useful electrical power by way of the generator 108, in a known manner.

Open-loop controllers, closed-loop controllers, programmable logic controllers, combinations thereof, may facilitate a connection between the input device 150 and the interface 128. Moreover, such input devices may also include remote control input devices such as wired or wireless telemetry devices, or combinations thereof.

In an embodiment, the interface 128 may include and/or represent a visual device that is configured to deliver a visual notification indicating an instruction receipt from the controller 124. In such a scenario, an access to the engine throttle (input device 150) may be separately and physically established, for example, by way of a conventional control lever that may be varied across discrete throttle settings—with each discrete throttle setting representing a specific fueling level of the engine 102. The interface 128 may be a visual display such as a light emitting diode (LED), a bulb, or a pop-up window displayed via touchscreens, liquid crystal displays (LCDs), and which may be in ready access for operator inference and use. In similar such embodiments, the interface 128 may include audible device, such as a speaker or an alarm that may generate an audible notification indicating an instruction (or alert) received from the controller 124. In yet another embodiment, the interface 128 may also be a combination of both an audible device and a visual display that may indicate the alert, or alerts, by way of both a visual notification and an audible notification.

### INDUSTRIAL APPLICABILITY

While the performance of a catalyst (component 110) in conventional aftertreatment systems may depend upon multiple factors, such as catalyst formulation, a size of the catalyst, mixing of a reductant within the exhaust gas, a reductant formulation, and a reductant dosing rate, it is important that a minimum temperature be maintained so that the catalyst (component 110) may effectively operate. During operations, when a minimum temperature requirement fails to meet the predetermined temperature threshold, such as in sub-freezing ambient temperature conditions, or when the temperature at the inlet 112 falls below 200° C., a considerable portion of HCs emitted by the engine 102 may bypass a stage of treatment. With each of the DOC, the SCR catalyst, and the DPF, being applied in conventional aftertreatment systems, such as the aftertreatment system 104, untreated HC emissions that bypass the stage of treatment may initially saturate the DOC. Following the DOC, the HC emissions may saturate the SCR catalyst, and, eventually, the DPF. As a result, an operating efficiency of each of the DOC, the SCR catalyst, and the DPF (collectively, component 110), may deteriorate, potentially leading to increased emissions of undesirable gaseous compounds. A sudden throttle increase may ignite the HC content laden within the component 110, but may potentially cause an exothermic event that could damage the component 110 (i.e. each of the DOC, the SCR catalyst, and the DPF). Therefore, if the percent load of HC exceeds the predetermined HC load threshold, the scheme 300 (see FIG. 3) that includes a stepwise increase in an engine power to one or more predetermined engine speeds for one or more predetermined durations is initiated. This scheme 300 will be discussed in connection with an exemplary method of operating the aftertreatment system 104, further below.

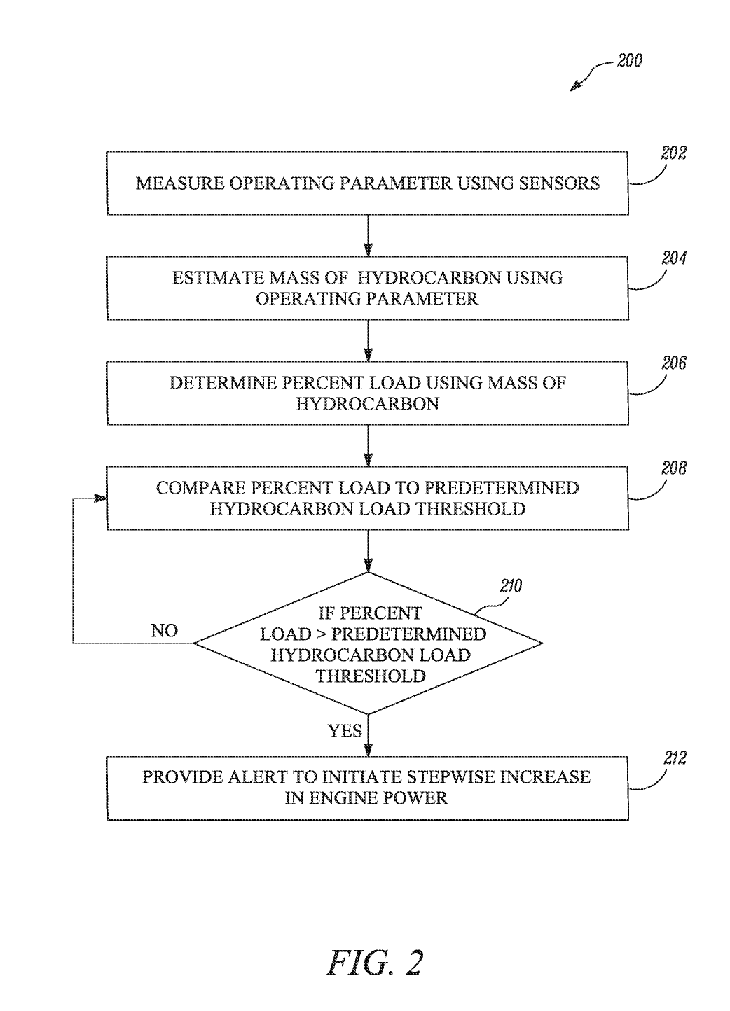

Referring to FIGS. 2 and 3, this exemplary method for operating the aftertreatment system 104 is discussed. This method of operating the aftertreatment system 104 is applied to release or free the component 110 of the HC content. The method is discussed by way of a flowchart 200 as shown in FIG. 2, and subsequent to the discussion of the flowchart 200, a discussion on the release of the HC content from the component 110 is continued by reference to the scheme 300 depicted in FIG. 3. Both the flowchart 200 and the scheme 300 may be described in conjunction with FIG. 1.

Referring to FIG. 2, the method initiates at stage 202. At stage 202, the sensors 132, 134, and 136, may measure at least one operating parameter of the engine system 100. The method proceeds to stage 204.

At stage 204, the microprocessor 130 estimates the mass of hydrocarbon (HC content) retained by the component 110 using the operating parameter measured by the sensors 132, 134, and 136. Such an estimation may be performed by tallying the operating parameters to a map data stored within the memory 140, for example. Alternatively, it is possible that the microprocessor 130 may estimate the mass of hydrocarbon by applying the operating parameters in one or more equations that may be sourced from the memory 140. In so doing, the microprocessor 130 derives the HC content retained by the component 110. The method proceeds to stage 206.

At stage 206, the microprocessor 130 may tally the HC content to another map data by which a percent load of the HC content may be determined. As with the stage 204 discussed above, it is possible that the microprocessor 130 derives the percent load alternatively by applying the HC content into equations that may be stored in the memory 140. The method proceeds to stage 208.

At stage 208, the microprocessor 130 compares the data related to the percent load of the HC content against the predetermined HC load threshold. The method proceeds to stage 210.

At stage 210, the microprocessor 130 determines whether the percent load is greater than the predetermined HC load threshold. The method proceeds to stage 212.

At stage 212, if the percent load is greater than the predetermined HC load threshold, the controller 124 generates or provides an alert, thus providing a signal or indicating a need to initiate the scheme 300. The alert may be displayed or outputted via the interface 128, and may be inferred by an operator of the engine system 100. In one embodiment, the alert includes the first alert and the predetermined HC load threshold is a first predetermined HC load threshold. It is possible that the controller 124 may generate the second alert upon the occurrence of: if the HC content (i.e. the percent load of HC) retained on the component 110 fails to drop below the first predetermined HC load threshold after a period. Alternatively, it is possible that the second alert is generated or provided upon the occurrence of: if the HC content (i.e. the percent load of HC) within the component 110 exceeds a second predetermined HC load threshold that is higher than the first predetermined HC load threshold.

At stage 212, upon receiving the alert through the interface 128, the operator initiates the scheme 300 of a stepwise increase in engine power (i.e. power of the engine 102) at predetermined engine speeds for predetermined durations. The scheme 300 has been described in detail below.

Referring to FIG. 3, the scheme 300 will now be discussed. The scheme 300 is as an example strategy to free the component 110 of the HC content and is discussed in connection with an engine system, such as the engine system 100, that is applied in a marine vessel, as has already been suggested above. Since such an engine system may include two engine hardware sets, the scheme 300 is described by way of two separate/individual operational steps. The engine hardware sets may be specific to application and operation (i.e. constant engine speed versus variable engine speed) along with either of the engines being attached to the generator 108 or to a propulsion system of an engine family. The propulsion engine may be similar to the depiction of the engine 102 in FIG. 1, but without the generator 108. Depending on the hardware set and application of the engine 102, the scheme 300 includes a set of steps that are prescribed to remove the HC content safely from the component 110. The scheme 300 may be performed subsequent to the receipt of the alert (or the second alert).

In general, each stepwise increase in the engine power, as disclosed by the scheme 300, includes modulating an engine power to obtain a predetermined temperature of the exhaust gas at the inlet 112 of the component 110, at each step. At each step, upon attaining the predetermined temperature, the engine power is maintained for a predetermined duration. If in any case, the temperature of the exhaust gas at the inlet 112 rises above the predetermined temperature at any step, the engine power may be reduced till the temperature lowers to the predetermined temperature, and then the predetermined temperature may be maintained for the predetermined duration. It may be noted that the stepwise increase in the engine power may be performed till a final predetermined engine power is obtained. The controller 124 may clear the alert (or the second alert) by maintaining the final predetermined engine power for a final predetermined duration.

Furthermore, at each successive step of the stepwise increase, the scheme 300 may include operating the engine 102 at a higher engine power relative to an engine power at a preceding step, for at least one of an equal or a higher predetermined duration, than a duration of the preceding step of the scheme 300. It may be noted that the engine 102 is operated at a higher engine power to attain a higher predetermined temperature of the exhaust gas at the inlet 112. A power of the engine 102 may be raised by at least one of increasing a fuel supply to the engine 102 and/or increasing a load applied to the engine 102. The load may correspond to an ‘electrical load’ of an electrical device or an electrical accessory (not shown). Therefore, modulating the engine power may correspond to modulating one of an engine speed or an engine load.

At start steps 302, 304, and 306, an operator of the engine 102 may choose between three urging factors, each of which may require the execution of the scheme 300. For the purpose of the present disclosure, an ‘urging factor’ may be any factor that may compel and/or encourage the operator to clear and free the component 110 of the HC content. A first urging factor may be a time for which the engine 102 has been idling (such as for the running period described above); a second urging factor may be a generation of the first alert by the controller 124 that indicates the ‘moderate severity state’ of the component 110; and a third urging factor may be a generation of the second alert by the controller 124 that indicates the ‘high severity state’ of the component 110. It may be understood that there could be higher or lesser number of urging factors than the ones described in the present disclosure. Based on any of such urging factors, the operator may initiate the scheme 300.

At next step 308, the operator may determine whether the alert is corresponding to the propulsion engine of the engine system 100 or the auxiliary engine of the engine system 100. If it is determined that the alert corresponds to the propulsion engine, the method proceeds to step 310.

At step 310, a rating of the propulsion engine may be determined. Depending upon the rating, the operator may execute a series of steps 312, 314, 316, and 318, as have been set out below.

At step 312, the operator may operate the propulsion engine at a predetermined engine speed, such as the first predetermined engine speed, till a first predetermined exhaust temperature is attained. Thereafter, the operator may operate the propulsion engine such that the first predetermined exhaust temperature is maintained for a first predetermined duration. Next, at step 314, the operator may operate the propulsion engine at a second predetermined engine speed till a second predetermined exhaust temperature is attained. Thereafter, the operator may operate the propulsion engine such that the second predetermined exhaust temperature is maintained for a second predetermined duration. Further, at step 316, the operator may operate the propulsion engine at a third predetermined engine speed till a third predetermined exhaust temperature is attained. Thereafter, the operator may operate the propulsion engine such that the third predetermined exhaust temperature is maintained for a third predetermined duration. At step 318, the operator may operate the propulsion engine at a fourth predetermined engine speed till a fourth predetermined exhaust temperature is attained. Thereafter, the operator may operate the propulsion engine such that the fourth predetermined exhaust temperature is maintained for a fourth predetermined duration (i.e. a final predetermined duration).

Conversely, if it is determined at step 308 that the alert corresponds to the auxiliary engine, the operator may proceed to execute a series of steps 320, 322, 324, and 326, from the step 308.

At step 320, a rating of the auxiliary engine may be determined. Depending upon the rating, the operator may execute a series of steps 322, 324, and 326, as have been set out below.

At step 322, the operator may operate the auxiliary engine at a fixed engine speed, with a first predetermined load till a first preset exhaust temperature is attained. Thereafter, the operator may operate the auxiliary engine such that the first preset exhaust temperature is maintained for a first preset duration. At step 324, the operator may operate the auxiliary engine at the same fixed engine speed, with a second predetermined load till a second preset exhaust temperature is attained. Thereafter, the operator may operate the auxiliary engine such that the second preset exhaust temperature is maintained for a second preset duration. At step 326, the operator may operate the auxiliary engine at the same fixed engine speed, with a third predetermined load till a third preset exhaust temperature is attained. Thereafter, the operator may operate the auxiliary engine such that the third preset exhaust temperature is maintained for a third preset duration (i.e. a final predetermined duration). It may be noted that the fixed engine speed may be a predetermined engine speed of the auxiliary engine.

Notably, the fourth predetermined engine speed, in case of the propulsion engine, defines a final predetermined engine speed, while the third predetermined load, in case of the auxiliary engine, defines a final predetermined engine load. Both the final predetermined engine speed and the final predetermined load correspond to the final predetermined engine power, while the fourth predetermined exhaust temperature and the third preset exhaust temperature correspond to the final predetermined temperature of the exhaust gas at the inlet 112. Once either or both of the steps 318 and/or 326 is performed, the controller 124 may clear the alert (or both the first alert and the second alert) at step 328, and the engine system 100 may be returned to normal work at step 330. It may be noted that the controller 124 may generate a dedicated, separate alert for each of the propulsion engine and the auxiliary engine.

Based on the description above, additional description is provided below, which provides exemplary experimental data that is established to be useful for clearing the HC content from a component, such as component 110, of a 3516® 1600/1800 rpm CAT propulsion engine system or a 3512® 1800 rpm CAT propulsion engine system. The forthcoming description is discussed in connection with FIG. 3 and includes assignment of exemplary values to certain steps of the scheme 300, as will be disclosed below.

At step 312, the first predetermined engine speed may be 800 rpm, the first predetermined exhaust temperature may be 250° C., and the first predetermined duration may be 5 minutes; at step 314 the second predetermined engine speed may be 900 rpm, the second predetermined exhaust temperature may be 345° C., and the second predetermined duration may be 5 minutes; at step 316 the third predetermined engine speed may be 1100 rpm, the third predetermined exhaust temperature may be 405° C., and the third predetermined duration may be 5 minutes; at step 318 the fourth predetermined engine speed may be 1300 rpm, the fourth predetermined exhaust temperature may be 445° C., and the fourth predetermined duration may be 20 minutes.

Similar to the description on the 3516® 1600/1800 rpm and the 3512® 1800 rpm CAT propulsion engine systems above, the forthcoming description includes an exemplary experimental data that is established to be useful for clearing the HC content from a component, such as component 110, of a 3512® 1600 rpm CAT propulsion engine systems.

At step 312, the first predetermined engine speed may be 1000 rpm, the first predetermined exhaust temperature may be 250° C., and the first predetermined duration may be 5 minutes; at step 314 the second predetermined engine speed may be 1100 rpm, the second predetermined exhaust temperature may be 300° C., and the second predetermined duration may be 10 minutes; at step 316 the third predetermined engine speed may be 1200 rpm, the third predetermined exhaust temperature may be 350° C., and the third predetermined duration may be 10 minutes; at step 318 the fourth predetermined engine speed may be 1300 rpm, the fourth predetermined exhaust temperature may be 375° C., and the fourth predetermined duration may be 20 minutes.

Further description below includes an exemplary experimental data that is established to be useful for clearing the HC content from a component, such as component 110, of a 3512® CAT auxiliary engine system. The forthcoming description is discussed in connection with FIG. 3 and includes assignment of exemplary values to certain steps of the scheme 300, as will be disclosed below.

At step 322, the fixed engine speed may be 1800 rpm, the first predetermined load may be 100 Kilowatts (kW), the first preset exhaust temperature may be 220° C., and the first preset duration may be 5 minutes; At step 324, the fixed engine speed may be 1800 rpm, the second predetermined load may be 300 kW, the second preset exhaust temperature may be 310° C., and the second preset duration may be 15 minutes; At step 326, the fixed engine speed may be 1800 rpm, the third predetermined load may be 600 kW, the third preset exhaust temperature may be 330° C., and the third preset duration may be 40 minutes.

Similar to the description of the 3512® CAT auxiliary engine system above, the forthcoming description includes an exemplary experimental data that is established to be useful for clearing the HC content from a component, such as component 110, of a 3516® CAT auxiliary engine system.

At step 322, the fixed engine speed may be 1800 rpm, the first predetermined load may be 133 kW, the first preset exhaust temperature may be 230° C., and the first preset duration may be 5 minutes; At step 324, the fixed engine speed may be 1800 rpm, the second predetermined load may be 400 kW, the second preset exhaust temperature may be 290° C., and the second preset duration may be 15 minutes; At step 326, the fixed engine speed may be 1800 rpm, the third predetermined load may be 800 kW, the third preset exhaust temperature may be 330° C., and the third preset duration may be 40 minutes.

By execution of the scheme 300 described above, it is possible to gradually oxidize and remove the HC and release the component 110 of HC. The scheme 300 and the thermal management system 120 also provides the ability to monitor a temperature of the inlet 112 and outlet 114 and the percent HC loading to bring the aftertreatment system back to normal or idle operating conditions. Moreover, since a timely maintenance activity may be carried out in such a manner, readily by an operator, it is also possible to prolong a work life of the component 110, and in general, the aftertreatment system 104. While a four-step process is described for the propulsion engines to clear the HC content from the component 110, and a three-step process is described for the auxiliary engines, other engines may require additional or lesser number of steps to clear the HC content effectively and efficiently from associated aftertreatment components. It may thus be noted that all such methodologies, similar to ones that have been disclosed above, and that are applied to clear aftertreatment components of similar such engines, may fall within the ambit of the present disclosure.

It should be understood that the above description is intended for illustrative purposes only and is not intended to limit the scope of the present disclosure in any way. Thus, one skilled in the art will appreciate that other aspects of the disclosure may be obtained from a study of the drawings, the disclosure, and the appended claim.

What is claimed is:

1. A method for operating an aftertreatment system of an engine system, the method comprising:
measuring, using one or more sensors, at least one operating parameter of the engine system;
estimating, by a controller, a mass of hydrocarbon retained by an aftertreatment component using the at least one operating parameter;
determining, by the controller, a percent load of hydrocarbon using the mass of hydrocarbon;
comparing, by the controller, the percent load to a predetermined hydrocarbon load threshold; and
providing at least one alert indicating a need to initiate a stepwise increase in an engine power to one or more predetermined engine speeds for one or more predetermined durations, if the percent load exceeds the predetermined hydrocarbon load threshold.

2. The method of claim 1 further comprising clearing the at least one alert by maintaining a final predetermined engine power for a final predetermined duration.

3. The method of claim 1, wherein for each stepwise increase in the engine power, the method further includes modulating the engine power to obtain a predetermined temperature of an exhaust gas at an inlet of the aftertreatment component, wherein upon attaining the predetermined temperature, the engine power is maintained for a predetermined duration.

4. The method of claim 3, wherein modulating the engine power corresponds to modulating one of an engine speed or an engine load.

5. The method of claim 1, wherein at each successive step of increase in the engine power, the method further includes operating an engine of the engine system at a higher engine power relative to an engine power at a preceding step, for at least one of an equal or a higher predetermined duration, than a duration of the preceding step.

6. The method of claim 1, wherein the at least one alert includes a first alert and the predetermined hydrocarbon load threshold is a first predetermined hydrocarbon load threshold, the method further including providing, by the controller, a second alert upon an occurrence of one of:
the percent load of hydrocarbon exceeding a second predetermined hydrocarbon load threshold, the second predetermined hydrocarbon load threshold being higher than the first predetermined hydrocarbon load threshold, or
the percent load of hydrocarbon failing to drop below the first predetermined hydrocarbon load threshold after a period.

7. The method of claim 1, wherein the at least one operating parameter includes a temperature and a mass flow of the exhaust gas at an inlet of the aftertreatment component.

8. The method of claim 1, wherein the engine power is raised by at least one of increasing a fuel or increasing a load applied to an engine of the engine system.

9. The method of claim 1 further including providing the at least one alert when an engine speed is below a first predetermined engine speed.

10. An aftertreatment system for an engine system, comprising:
an aftertreatment component configured to receive exhaust gas from an engine;
one or more sensors configured to measure at least one operating parameter of the engine system; and
a controller in communication with the one or more sensors and the engine, and being configured to:
estimate a mass of hydrocarbon retained by an aftertreatment component using the at least one operating parameter;
determine a percent load of hydrocarbon using the mass of hydrocarbon;
compare the percent load to a predetermined hydrocarbon load threshold; and
provide at least one alert indicating a need to initiate a stepwise increase in an engine power to one or more predetermined engine speeds for one or more predetermined durations, if the percent load exceeds the predetermined hydrocarbon load threshold.

11. The aftertreatment system of claim 10, wherein the aftertreatment component is at least one of a diesel oxidation catalyst, a selective catalytic reduction catalyst, and a diesel particulate filter.

12. The aftertreatment system of claim 10, wherein the controller is configured to provide the at least one alert when an engine speed is below a first predetermined engine speed.

13. The aftertreatment system of claim 10, further including an interface coupled to the controller, the interface being configured to indicate the at least one alert as an audible notification or a visual notification, or a combination of the audible notification and the visual notification.

14. The aftertreatment system of claim 10, wherein the controller is configured to clear the at least one alert when a final predetermined engine power is maintained for a final predetermined duration.

15. The aftertreatment system of claim 10, wherein the at least one alert includes a first alert and the predetermined hydrocarbon load threshold is a first predetermined hydrocarbon load threshold, the controller configured to provide a second alert upon an occurrence of one of:
the percent load of hydrocarbon exceeding a second predetermined hydrocarbon load threshold, the second predetermined hydrocarbon load threshold being higher than the first predetermined hydrocarbon load threshold, or
the percent load of hydrocarbon failing to drop below the first predetermined hydrocarbon load threshold after a period.

16. An engine system, comprising:
an aftertreatment system adapted to treat exhaust gas of an engine, the aftertreatment system including:
an aftertreatment component configured to receive exhaust gas from the engine;
one or more sensors configured to measure at least one operating parameter of the engine system; and
a controller in communication with the one or more sensors and the engine, and being configured to:
estimate a mass of hydrocarbon retained by an aftertreatment component using the at least one operating parameter;
determine a percent load of hydrocarbon using the mass of hydrocarbon;
compare the percent load to a predetermined hydrocarbon load threshold; and
provide at least one alert indicating a need to initiate a stepwise increase in an engine power to one or more predetermined engine speeds for one or more predetermined durations, if the percent load exceeds the predetermined hydrocarbon load threshold.

17. The engine system of claim 16, wherein the aftertreatment component is at least one of a diesel oxidation catalyst, a selective catalytic reduction catalyst, and a diesel particulate filter.

18. The engine system of claim 16, further including an interface coupled to the controller, the interface being configured to indicate the at least one alert as an audible notification or a visual notification, or a combination of the audible notification and the visual notification.

19. The engine system of claim 16, wherein the controller is configured to clear the at least one alert when a final predetermined engine power is maintained for a final predetermined duration.

20. The engine system of claim 16, wherein the at least one alert includes a first alert and the predetermined hydrocarbon load threshold is a first predetermined hydrocarbon load threshold, the controller configured to provide a second alert upon an occurrence of at least one of:
the percent load of hydrocarbon exceeding a second predetermined hydrocarbon load threshold, the second predetermined hydrocarbon load threshold being higher than the first predetermined hydrocarbon load threshold, or
the percent load of hydrocarbon failing to drop below the first predetermined hydrocarbon load threshold after a period.
